(19) United States
(12) Patent Application Publication
(10) Pub. No.: US 2024/0169016 A1
(43) Pub. Date: May 23, 2024

(54) SPATIOTEMPORAL DATA PROCESSING APPARATUS AND METHOD BASED ON GRAPH NEURAL CONTROLLED DIFFERENTIAL EQUATION

(71) Applicant: University Industry Foundation, Yonsei University, Seoul (KR)

(72) Inventors: Noseong PARK, Seoul (KR); Jeongwhan CHOI, Seoul (KR); Jeehyun HWANG, Seoul (KR); Hwangyong CHOI, Seoul (KR)

(73) Assignee: University Industry Foundation, Yonsei University, Seoul (KR)

(21) Appl. No.: 18/085,109

(22) Filed: Dec. 20, 2022

(30) Foreign Application Priority Data
Nov. 14, 2022 (KR) 10-2022-0151819

(51) Int. Cl. G06F 17/13

(52) U.S. Cl. CPC G06F 17/13

(57) ABSTRACT

There is provided a spatiotemporal data processing including a preprocessing unit that generates a continuous path for each node in time series data, and a main processing unit that combines a graph convolution network (GCN) with a neural controlled differential equation (NCDE) for the generated path to perform integration processing on temporal information and spatial information, and the main processing unit performs temporal processing and spatial processing on each node with two controlled differential equation (CDE) functions to calculate a last hidden vector and forecast an output layer.

### CROSS-REFERENCE TO PRIOR APPLICATION

This application claims priority to Korean Patent Application No. 10-2022-0151819 (filed on Nov. 14, 2022), which is hereby incorporated by reference in its entirety.

### BACKGROUND

The present disclosure relates to a spatiotemporal data processing technology, and more particularly, to an STG-NCDE technology capable of increasing the accuracy of spatiotemporal graph data processing by combining a neural controlled differential equation (NCDE) for temporal processing with an NCDE for spatial processing into a single framework on the basis of an NCDE.

Spatiotemporal graph data is frequently generated in a real application program from traffic to climate forecasting. For example, a traffic forecasting task initiated by California Performance of Transportation (PeMS) is one most popular problem in the field of spatiotemporal processing.

Given a time series of a graph { [symbol] ₜ_{ᵢ} [symbol] (V, ε, Fᵢ, tᵢ)}ᵢ₌₀^{N}, where [symbol] is a set of fixed nodes, ε is a set of fixed edges, tᵢ is a point in time at which [symbol] ₜ_{ᵢ} is observed, and Fᵢ ∈ [symbol] is a feature matrix at time tᵢ including a D-dimensional input feature of a node, Ŷ ∈ [symbol] is forecast in spatiotemporal forecasting. For example, given N+1 past traffic patterns, traffic for each position in a road network is forecast at S points in time. Here, M=1 because | [symbol] | is the number of positions at which forecasting is performed, and a volume is a scalar, that is, the number of vehicles. [symbol] and ε do not change over time. That is, a graph topology is fixed, but a node input function can change over time. Various technologies have been proposed for this task.

Meanwhile, an NCDE, which is regarded as a continuous analogue of recurrent neural networks (RNNs), is defined by the following equation.

$$\begin{matrix}z ( T ) = z ( 0 ) + {\int }_{0}^{T} f ( z ( t ) ; {θ}_{f} ) dX ( t ) \\ = z ( 0 ) + {\int }_{0}^{T} f ( z ( t ) ; {θ}_{f} ) \frac{dX ( t )}{dt} dt\end{matrix} \qquad [ Equation ]$$

Here, X is a continuous path having a value in a Banach space. An entire trajectory of z(t) is controlled over time by the path X. Tilting a controlled differential equation (CDE) function f with respect to a downstream task is a core of the NCDE.

A CDE theory was developed to extend a stochastic differential equation and an Itô calculus far beyond a simimartingale setting of X. That is, reduction to the stochastic differential equation is performed only when X satisfies a simimartingale condition. For example, a general example of the path X is a Wiener process in the case of the stochastic differential equation. However, in the CDE, the path X need not be such a simimartingale or martingale process. The NODE is a technology for parameterizing such a CDE and performing learning in data. Further, the NODE is the same as a continuous RNN and shows latest accuracy in many time series tasks and data.

However, a method for combining an NCDE technology (that is, temporal processing) with a graph convolution processing technology (that is, spatial processing) has not yet been studied.

### PATENT DOCUMENT

Korean Patent No. 10-2254765 (May 14, 2021)

### SUMMARY

An embodiment of the present disclosure is to provide an STG-NCDE technology capable of increasing the accuracy of spatiotemporal graph data processing by combining an NCDE for temporal processing with an NCDE for spatial processing into a single framework on the basis of an NCDE.

Among the embodiments, a spatiotemporal data processing apparatus based on a graph neural controlled differential equation may include a preprocessing unit configured to generate a continuous path for each node in time series data; and a main processing unit configured to combine a graph convolution network (GCN) with a neural controlled differential equation (NCDE) for the generated path to perform integration processing on temporal information and spatial information, wherein the main processing unit may perform temporal processing and spatial processing on each node with two controlled differential equation (CDE) functions to calculate a last hidden vector and forecast an output layer.

The preprocessing unit may perform an interpolation algorithm on each node to generate the continuous path.

The preprocessing unit may use a natural cubic spline as the interpolation algorithm.

The main processing unit may include a first NCDE module configured to perform the temporal processing on the continuous path of each node to generate a hidden trajectory of the temporal information; and a second NCDE module configured to perform the spatial processing on the continuous path of each node to generate a hidden trajectory of the spatial information.

The first NCDE module may stake the hidden trajectories for all the nodes to generate a matrix, and individually process respective rows of the matrix using a CDE function to convert the matrix into a continuous RNN.

The main processing unit may further include an initial value generation module configured to generate initial values of the temporal processing and the spatial processing, and train parameters of an initial value generation layer, a CDE function including a node embedding matrix, and an output layer.

Among the embodiments, a spatiotemporal data processing method based on a graph neural controlled differential equation may include: a preprocessing step of generating a continuous path for each node in time series data; and a main processing step of combining a graph convolution network (GCN) with a neural controlled differential equation (NCDE) for the generated path to perform integration processing on temporal information and spatial information, wherein the main processing step may include performing temporal processing and spatial processing on each node with two controlled differential equation (CDE) functions to calculate a last hidden vector and forecast an output layer.

The preprocessing step may include performing an interpolation algorithm on each node to generate the continuous path.

The preprocessing step may include using a natural cubic spline as the interpolation algorithm.

The main processing step may include a temporal processing step of performing the temporal processing on the continuous path of each node through a first NCDE module to generate a hidden trajectory of the temporal information; and a spatial processing step of performing the spatial processing on the continuous path of each node through a second NCDE module to generate a hidden trajectory of spatial information.

The temporal processing step may include staking the hidden trajectories for all the nodes to generate a matrix, and individually processing respective rows of the matrix using a CDE function to convert the matrix into a continuous RNN.

The main processing step further may include an initial value generation step of generating initial values of the temporal processing and the spatial processing, and training parameters of an initial value generation layer, a CDE function including a node embedding matrix, and an output layer.

The disclosed technology can have the following effects. However, since this does not mean that a specific embodiment must include all of the following effects or only the following effects, it should not be understood that the scope of rights of the disclosed technology is limited thereby.

With the spatiotemporal data processing apparatus and method based on a graph neural controlled differential equation according to the present disclosure, it is possible to increase the accuracy of spatiotemporal graph data processing by combining an NCDE for temporal processing with an NCDE for spatial processing into a single framework on the basis of an NCDE.

Therefore, it is possible to improve performance of forecasting irregular traffic through an STG-NCED scheme of the present disclosure.

### BRIEF DESCRIPTION OF THE DRAWINGS

FIG. 1 is a diagram illustrating a spatiotemporal data processing system according to the present disclosure.

FIG. 2 is a diagram illustrating a system configuration of a spatiotemporal data processing apparatus according to the present disclosure.

FIG. 3 is a diagram illustrating a functional configuration of the spatiotemporal data processing apparatus according to the present disclosure.

FIG. 4 is a flowchart illustrating a spatiotemporal data processing method based on a graph neural controlled differential equation according to the present disclosure.

FIGS. 5A and 5B are diagrams illustrating workflows of an existing NCDE and an NCDE according to the present disclosure.

FIGS. 6 to 10 are diagrams illustrating experimental results regarding the present disclosure.

### DETAILED DESCRIPTION

Since the description of the present disclosure is only an embodiment for structural or functional description, the scope of rights of the present disclosure should not be construed as being limited by the embodiments described herein. That is, since the embodiment can be changed in various ways and can have various forms, it should be understood that the scope of rights of the present disclosure includes equivalents capable of realizing the technical idea. Further, since the object or effects presented in the present disclosure does not mean that a specific embodiment should include all of these or only such effects, the scope of rights of the present disclosure should not be construed as being limited thereto.

Meanwhile, the meanings of terms described herein should be understood as follows.

Terms first, second, etc. may be used herein to distinguish one element from another, and the scope of rights should not be limited by these terms. For example, a first element could be termed a second element, and, similarly, a second element could be termed a first element.

It will be understood that, when an element is referred to as being “connected” or “coupled” to another element, it can be directly connected or coupled to the other element or intervening elements may be present. In contrast, it will be understood that, when an element is referred to as being “directly connected” or “directly coupled” to another element, there are no intervening elements present. Meanwhile, other words used to describe a relationship between elements, that is, “between” versus “directly between,” “adjacent” versus “directly adjacent,” etc. should be interpreted in a like fashion.

It will be understood that the singular forms “a,” “an” and “the” include the plural forms as well, unless the context clearly indicates otherwise, and it will be further understood that the terms “comprise,” “include”, and “have” specify the presence of stated features, integers, steps, operations, elements, components, and/or combinations thereof, but do not preclude the presence or addition of one or more other features, integers, steps, operations, elements, components, and/or combinations thereof.

In respective steps, identification signs (for example, a, b, and c) are used for convenience of description, and the identification signs does not describe an order of the respective steps, and the respective steps may occur in a different order than specified, unless a specific order is clearly described in the context. That is, the respective steps may occur in the same order as specified, may be performed substantially simultaneously, or may be performed in the reverse order.

The present disclosure can be implemented as computer-readable code on a computer-readable recording medium, and the computer-readable recording medium includes all types of recording devices storing data that can be read by a computer system. Examples of the computer-readable recording medium include a ROM, a RAM, a CD-ROM, a magnetic tape, a floppy disk, and an optical data storage device. Further, the computer-readable recording medium may be distributed to computer systems connected through a network and computer-readable codes may be stored and executed in a distributed manner.

All terms used herein have the same meaning as commonly understood by those skilled in the art to which the present disclosure belongs, unless defined otherwise. Terms defined in commonly used dictionaries should be interpreted as consistent with meanings in the context of the related art, and cannot be interpreted as having ideal or excessively formal meanings unless explicitly defined in the present application.

First, a neural ordinary differential equation (hereinafter referred to as NODE) will be described prior to description of an NCDE.

In the NODE, a method for continuously modeling a residual neural network (ResNet) using a differential equation is introduced. The NODE can be expressed as shown in Equation 1 below.

z(T)=z(0)+∫₀^{T}f(z(t), t;θ_{f})dt [Equation 1]

Here, a neural network parameterized by θ_{f} approximates z(t)dt and depends on various ODE solvers, including an explicit Euler method, a fourth-order Runge-Kutta (RK4), and Dormand-Prince (DOPRI) method, to solve the integral problem. In particular, when Equation 2 is solved by the explicit Euler method, Equation 2 is reduced to a residual connection. In this connection, the NOED generalizes ResNet in a continuous manner.

Next, the NCDE will be described.

The NODE generalizes ResNet, whereas the NCDE generalizes RNN in a continuous manner in Equation 2 below.

$$\begin{matrix}z ( T ) = z ( 0 ) + {\int }_{0}^{T} f ( z ( t ) ; {θ}_{f} ) dX ( t ) \\ = z ( 0 ) + {\int }_{0}^{T} f ( z ( t ) ; {θ}_{f} ) \frac{dX ( t )}{dt} dt\end{matrix} \qquad [ Equation 2 ]$$

The controlled differential equation (CDE) is a more advanced concept than an ordinary differential equation (ODE). The integral problem in Equation 1 is a Rienmann integral problem, whereas Equation 1 is a Riemann-Stieltjes integral problem. In Equation 2, z(t)/dt is approximated as

$$f ( z ( t ) ; {θ}_{f} ) \frac{dX ( t )}{dt} .$$

When z(t)/dt is somehow successfully formulated in a close mathematical form, this can be solved using an existing ODE solver. Therefore, many technologies developed to solve the NODE may also be applied to the NCDE.

Spatiotemporal processing of a time series graph { [symbol] ₜ_{ᵢ} [symbol] ( [symbol] , ε, Fᵢ)}ᵢ₌₀^{N} is obviously more difficult than the spatial processing only (that is, GCN) or temporal processing only (that is, RNN). Thus, many neural networks in which GCN and RNN are combined have been proposed.

In the present disclosure, a new spatiotemporal model based on NCDE and adaptive topology generation technologies is designed.

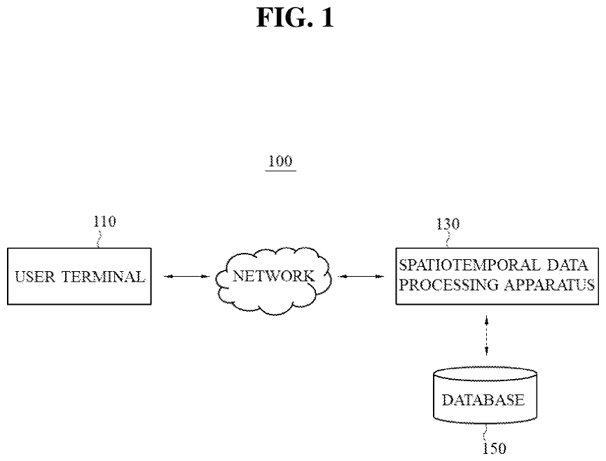

Hereinafter, the spatiotemporal data processing apparatus and method according to the present disclosure will be described in more detail with reference to FIGS. 1 to 4.

FIG. 1 is a diagram illustrating a spatiotemporal data processing system according to the present disclosure.

Referring to FIG. 1, a spatiotemporal data processing system 100 may be implemented to execute a spatiotemporal data processing method based on a graph neural controlled differential equation according to the present disclosure. To this end, the spatiotemporal data processing system 100 may include a user terminal 110, a spatiotemporal data processing apparatus 130, and a database 150.

The user terminal 110 may correspond to a terminal device that is operated by a user. For example, the user may process an operation regarding generating and learning spatiotemporal data for traffic forecasting through the user terminal 110. In an embodiment of the present disclosure, a user may be understood as one or more users, and a plurality of users may be divided into one or more user groups.

Further, the user terminal 110 may correspond to a computing device that operates in conjunction with the spatiotemporal data processing apparatus 130 as a device constituting the spatiotemporal data processing system 100. For example, the user terminal 110 may be implemented as a smart phone, a laptop computer, or a computer that is operable in a state in which the user terminal 110 is connected to the spatiotemporal data processing apparatus 130, but the present disclosure is not necessarily limited thereto and is also implemented with various devices including a tablet PC or the like. Further, in the user terminal 110, a dedicated program or application (or app) for interworking with the spatiotemporal data processing apparatus 130 may be installed and executed.

The spatiotemporal data processing apparatus 130 may be implemented as a server corresponding to a computer or program that performs the spatiotemporal data processing method based on a graph neural controlled differential equation according to the present disclosure. Further, the spatiotemporal data processing apparatus 130 may be connected to the user terminal 110 over a wired network, or a wireless network such as Bluetooth, WiFi, or LTE, and may transmit or receive data to or from the user terminal 110 over the network. Further, the spatiotemporal data processing apparatus 130 may be implemented to operate in a state in which the spatiotemporal data processing apparatus 130 is connected to an independent external system (not illustrated in FIG. 1) in order to perform related operations.

The database 150 may correspond to a storage device that stores various pieces of information necessary for an operation process of the spatiotemporal data processing apparatus 130. For example, the database 150 may store information on learning data that is used in a spatiotemporal data processing process, and may store information on a model for learning or a learning algorithm, but the present disclosure is not necessarily limited thereto and the spatiotemporal data processes apparatus 130 may store collected or processed information in various forms in a process of performing the spatiotemporal data processing method based on a graph neural controlled differential equation according to the present disclosure.

Meanwhile, in FIG. 1, the database 150 is shown as a device independent of the spatiotemporal data processing apparatus 130, but the present disclosure is not necessarily limited thereto and it is obvious that the database 150 may be implemented to be included in the spatiotemporal data processing apparatus 130 as a logical storage device.

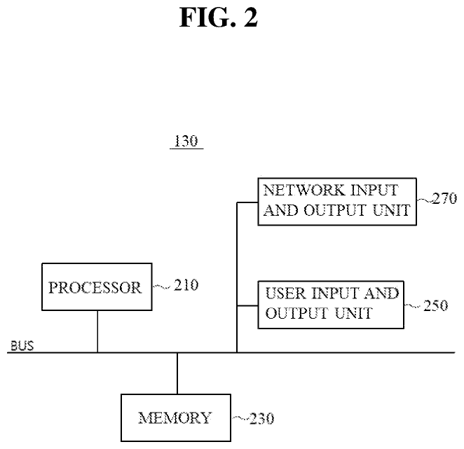

FIG. 2 is a diagram illustrating a system configuration of the spatiotemporal data processing apparatus according to the present disclosure.

Referring to FIG. 2, the spatiotemporal data processing apparatus 130 may include a processor 210, a memory 230, a user input and output unit 250, and a network input and output unit 270.

The processor 210 may execute a spatiotemporal data processing procedure based on a graph neural controlled differential equation according to the present disclosure, manage the memory 230 read or written in such a process, and schedule a synchronization time between a volatile memory and a non-volatile memory in the memory 230. The processor 210 may control an overall operation of the spatiotemporal data processing apparatus 130, and be electrically connected to the memory 230, the user input and output unit 250, and the network input and output unit 270 to control a data flow between these. The processor 210 may be implemented by a central processing unit (CPU) of the spatiotemporal data processing apparatus 130.

The memory 230 may be implemented as a non-volatile memory such as a solid state disk (SSD) or a hard disk drive (HDD) and include a secondary storage device used to store all pieces of data necessary for the spatiotemporal data processing apparatus 130, or may include a main memory implemented as a volatile memory such as a random access memory (RAM). Further, the memory 230 may store a set of instructions for executing a spatiotemporal data processing method based on a graph neural controlled differential equation according to the present disclosure by being executed by the electrically connected processor 210.

The user input and output unit 250 may include an environment for receiving a user input, and an environment for outputting specific information to the user, and may include an input device including an adapter such as a touch pad, a touch screen, an on-screen keyboard, or a pointing device, and an output device including an adapter such as a monitor or a touch screen. In one embodiment, the user input and output unit 250 may correspond to a computing device connected through a remote connection, and in such a case, the spatiotemporal data processing apparatus 130 may be implemented as an independent server.

The network input and output unit 270 may provide a communication environment for connection to the user terminal 110 through a network, and may include, for example, an adapter for communication, such as a local area network (LAN), a metropolitan area network (MAN), a wide area network (WAN), and a value added network (VAN). Further, the network input and output unit 270 may be implemented to provide a short-range communication function such as WiFi or Bluetooth or a 4G or higher wireless communication function for wireless data transmission.

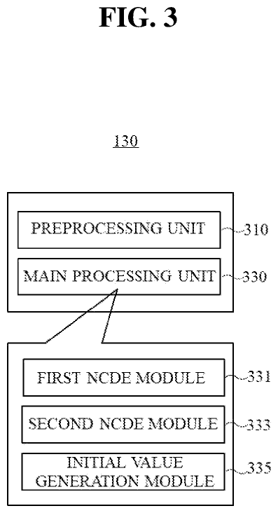

FIG. 3 is a diagram illustrating a functional configuration of the spatiotemporal data processing apparatus according to the present disclosure.

Referring to FIG. 3, the spatiotemporal data processing apparatus 130 may include a preprocessing unit 310 and a main processing unit 330.

The preprocessing unit 310 may generate a continuous path for each node in time series data. Here, the preprocessing unit 310 may generate the continuous path by performing an interpolation algorithm for each node. The preprocessing unit 310 may use a natural cubic spline as the interpolation algorithm.

The main processing unit 330 may perform integration processing on temporal information and spatial information by combining a graph convolution network (GCN) and a neural controlled differential equation (NCDE) for the generated path. Here, the main processing unit 330 may perform temporal processing and spatial processing on each node using two controlled differential equation (CDE) functions to calculate a final hidden vector and forecast an output layer.

The main processing unit 330 may be implemented by including a spatiotemporal graph neural controlled differential equation (STG-NCDE). As a configuration for this, the main processing unit 330 may include two NCDE modules 331 and 333. Among the two NCDE modules 331 and 333, the first NCDE module 331 can process the temporal information, and the second NCDE module 333 can process the spatial information. Here, the first and second NCDE modules 331 and 333 may be integrated and implemented to integrate the temporal processing and the spatial processing.

The first NCDE module 331 may perform the temporal processing on the continuous path of each node to generate a hidden trajectory of the temporal information. Here, the first NCDE module 331 may stake hidden trajectories for all the nodes to generate a matrix, and individually process respective rows of the matrix using a CDE function to convert the matrix into a continuous RNN. The second NCDE module 333 may perform the spatial processing on the continuous path of each node to generate a hidden trajectory of the spatial information.

The main processing unit 330 may further include an initial value generation module 335 that generates initial values for the temporal processing and the spatial processing, and trains parameters of an initial value generation layer, a CDE function including a node embedding matrix, and the output layer.

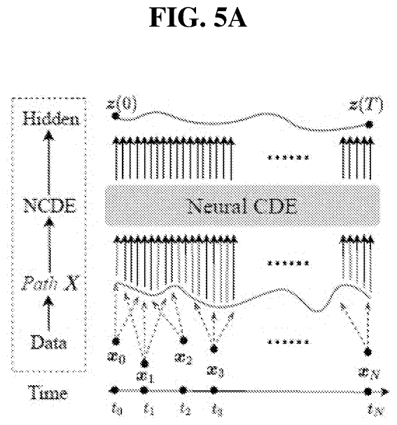

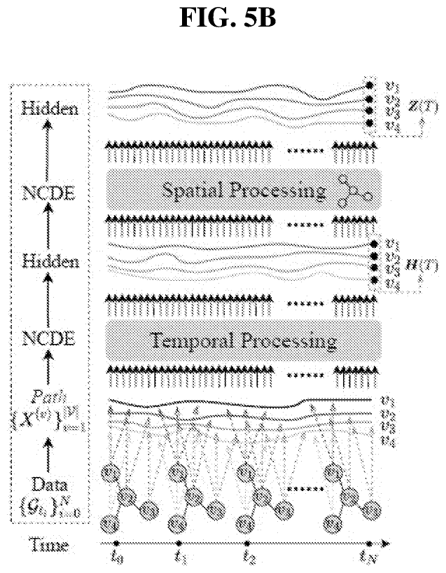

Referring to FIGS. 5A and 5B, in an existing NCDE workflow of FIG. 5A for time series processing, since the path X is generated by an interpolation algorithm, this is robust to irregular time series data. An STG-NCDE workflow proposed in the present disclosure may include one preprocessing and one main processing step, as illustrated in FIG. 5B.

In the preprocessing step, a continuous path X^{(ν)} is created for each node ν where 1≤ν≤| [symbol] | in {Fᵢ^{(ν)}}ᵢ₌₀^{N}. Here, Fᵢ^{(ν)} ∈ [symbol] means a v-th row of Fᵢ, and {Fᵢ^{(ν)}} represents time series of input features of ν. The present disclosure can use a natural cubic spline method to interpolate discrete time series {Fᵢ^{(ν)}} and construct the continuous path. The natural cubic spline has characteristics that i) the continuous path is generated, and ii) the generated path can be differentiated twice, which are suitable for use in the method of the present disclosure. In particular, the second characteristic is important when a gradient of the proposed model is calculated.

The preprocessing step occurs before the model is trained. In a main step of the present disclosure of combining GCN and NCDE technologies for performing a convolution operation on data represented by a graph, the last hidden vector for each node ν expressed by z^{(ν)}(T) is calculated.

Then, an output layer that forecasts [symbol] ∈ [symbol] for each node ν is included. After such forecasting is collected for all modes in V, a forecasting matrix [symbol] ∈ [symbol] is included.

The STG-NCDE proposed in the present disclosure is configured of two NCDEs. One of the NCDEs processes the temporal information and the other processes the spatial information.

A first NCDE for temporal processing can be written as Equation 3 below.

$${h}^{( v )} ( T ) = {h}^{( v )} ( 0 ) + {\int }_{0}^{T} f ( {h}^{( v )} ( t ) ; {θ}_{f} ) \frac{{dX}^{( v )} ( t )}{dt} dt \qquad [ Equation 3 ]$$

Here, h^{(ν)}(t) is a hidden trajectory (time t ∈[0, T]) of temporal information of the node ν. After h^{(ν)}(t) is stacked for all ν, a matrix H(t) ∈ [symbol] may be defined. Therefore, hidden information of time processing results is included in a trajectory generated by H(t) for time t. Equation 3 above may be equally rewritten as shown in Equation 4 below using a matrix notation.

$$H ( T ) = H ( 0 ) + {\int }_{0}^{T} f ( H ( t ) ; {θ}_{f} ) \frac{dX ( t )}{dt} dt \qquad [ Equation 4 ]$$

Here, X(t) is a matrix whose ν-th row is X^{(ν)}. A CDE function f individually processes resepctive rows of H(t). A key to this design is a method of defining the CDE function f parameterized by θ_{f}. f may not need to be an RNN, but instead, Equation 4 is converted to a continuous RNN by performing a design with only fully-connected layers.

Thereafter, the second NCDE starts spatial processing as shown in Equation 5 below.

$$Z ( T ) = Z ( 0 ) + {\int }_{0}^{T} g ( Z ( t ) ; {θ}_{g} ) \frac{dH ( t )}{dt} dt \qquad [ Equation 5 ]$$

Here, the hidden trajectory Z(t) is controlled by H(t) generated by time processing.

A single equation such as Equation 6 below in which both the temporal processing and the spatial processing are integrated is obtained after Equations 4 and 5 above are combined.

$$Z ( T ) = Z ( 0 ) + {\int }_{0}^{T} g ( Z ( t ) ; {θ}_{g} ) f ( H ( t ) ; {θ}_{f} ) \frac{dX ( t )}{dt} dt \qquad [ Equation 6 ]$$

Here, Z(t) ∈ [symbol] is a matrix generated after a hidden trajectories z^{(ν)} for all ν are stacked. In this NCDE, the hidden trajectory z^{(ν)} is generated in consideration of a nearby trajectory for ease of writing, and a matrix notation of Equations 5 and 6 above is used. A key part is a method of designing a CDE function g parameterized by θ_{g} for spatial processing.

Two CDE functions f and g will be described.

Definition of f: [symbol] → [symbol] is as shown in Equation 7 below.

$$\begin{matrix}f ( H ( t ) ; {θ}_{f} ) = ψ ( {FC}_{\vert 𝒱 \vert \times dim ( {h}^{( v )} \to \vert 𝒱 \vert \times dim ( {h}^{( v )} )} ( {A}_{K} ) ) , \\ ⋮ \\ {A}_{1} = σ ( {FC}_{\vert 𝒱 \vert \times dim ( {h}^{( v )} \to \vert 𝒱 \vert \times dim ( {h}^{( v )} )} ( {A}_{0} ) ) , \\ {A}_{0} = σ ( {FC}_{\vert 𝒱 \vert \times dim ( {h}^{( v )} \to \vert 𝒱 \vert \times dim ( {h}^{( v )} )} ( H ( t ) ) )\end{matrix}$$

Here, σ is a rectified linear unit, ψ is a hyperbolic tangent, and FC_{input_size→output_size} means a fully connected layer with an input size of input_size and an output size of output_size . θ_{f} represents a parameter of the fully connected layer. This function f independently processes the respective rows of H(t) with K fully connected layers.

One or more CDE functions g should be defined for the spatial processing.

Definition of g: [symbol] → [symbol] is as shown in Equation 8 below.

g(Z(t);θ_{g})=ψ(F [symbol] (B₁)),

B₁=(I+φ(σ(E·E^{T}))) B₀Wₛₚₐₜᵢₐₗ,

B₀=σ(F [symbol] (Z(t))).

Here, I is a | [symbol] |×| [symbol] | identity matrix, φ is a softmax activation, E ∈ [symbol] 0 is a trainable node-embedding matrix, E^{T} is a transpose, and Wₛₚₐₜᵢₐₗ is a trainable weight transformation matrix. Conceptually, φ(σ(E·E^{T})) corresponds to a normalized adjacency matrix [symbol] where A=σ(E·E^{T}) and the softmax activation serve to normalize an adaptive adjacency matrix (Wu et al. 2019; Bai et al. 2020). The present disclosure is also the same as a first-order Chebyshev polynomial expansion (Kipf and Welling 2017) of a graph convolution operation using the normalized adaptive adjacency matrix without mixing rows of input matrix Z(t) and B₁ in Equation 8 above.

An initial value of the time processing, that is, H(0) is generated from Fₜ_{₀} as follows:

H(0)=FC_{D→dim(h}_{^{(ν)}}₎(Fₜ_{₀}):

The following similar strategy is also used to generate Z(0):

Z(0)=FC_{dim(h}_{^{(ν)}}_{)→dim(z}_{^{(ν)}}₎(H(0))

After such initial values are generated for the two NCDEs, the Riemann-Stieltjes integral problem in Equation 6 above may be solved and then Z(T) may be calculated.

An augmented ODE such as Equation 9 below is defined to implement Equation 6 above without separately implementing Equations 4 and 5 above.

$$\frac{d}{dt} [ \begin{matrix}Z ( t ) \\ H ( t )\end{matrix} ] = [ \begin{matrix}g ( Z ( t ) ; {θ}_{g} ) f ( H ( t ) ; {θ}_{f} ) \frac{dX ( t )}{dt} \\ f ( H ( t ) ; {θ}_{f} ) \frac{dX ( t )}{dt}\end{matrix} ] \qquad [ Equation 9 ]$$

Here, the initial values Z(0) and H(0) may be generated in the aforementioned manner. Then, parameters of an initial value generation layer, a CDE function including the node embedding matrix E, and the output layer can be trained. In z^{(ν)}(T), that is, a ν-th row of Z(T), an output layer [symbol] is generated as shown in Equation 10 below.

[symbol]

= [symbol] (T)Wₒᵤₜₚᵤₜ+bₒᵤₜₚᵤₜ [Equation 10]

Here Wₒᵤₜₚᵤₜ ∈ [symbol] and bₒᵤₜₚᵤₜ ∈ [symbol] are the trainable weight and a bias of the output layer. A L¹ loss is used as a training target defined by Equation 11 below.

$$ℒ = \frac{{\sum }_{τ ∈ 𝒯} {\sum }_{υ ∈ 𝒱} {‖ {y}^{( τ , υ )} - {\hat{y}}^{( τ , υ )} ‖}_{1}}{\vert 𝒱 \vert \times \vert 𝒯 \vert} \qquad [ Equation 11 ]$$

Here, [symbol] is a training set, τ is a training sample, and [symbol] is a measured value of the node ν in τ. Further, a standard L² regularization of the parameter, that is, weight decay is used.

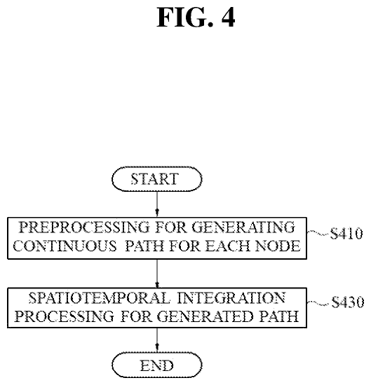

FIG. 4 is a flowchart illustrating the spatiotemporal data processing method based on a graph neural controlled differential equation according to the present disclosure.

Referring to FIG. 4, the spatiotemporal data processing apparatus 130 may generate the continuous path for each node of time-series data through the preprocessing unit 310 (step S410). Thereafter, the spatiotemporal data processing apparatus 130 may combine the graph convolution network (GCN) with the neural controlled differential equation (NCDE) to perform integration processing on the temporal information and the spatial information through the two neural controlled differential equation (NCDE) modules 331 and 333 in the main processing unit 330 (step S430). Here, the spatiotemporal data processing apparatus 130 may perform the temporal processing and the spatial processing on each node with two controlled differential equation (CDE) functions to calculate the last hidden vector, and forecast the output layer.

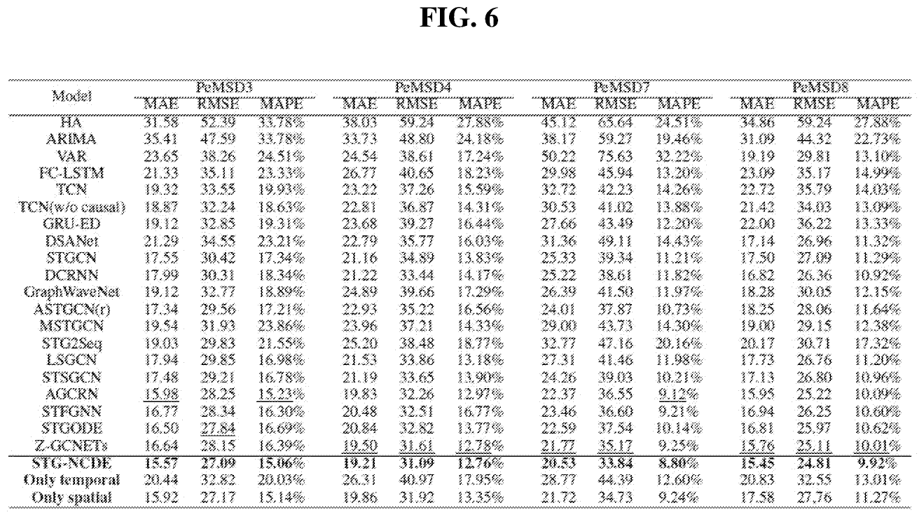

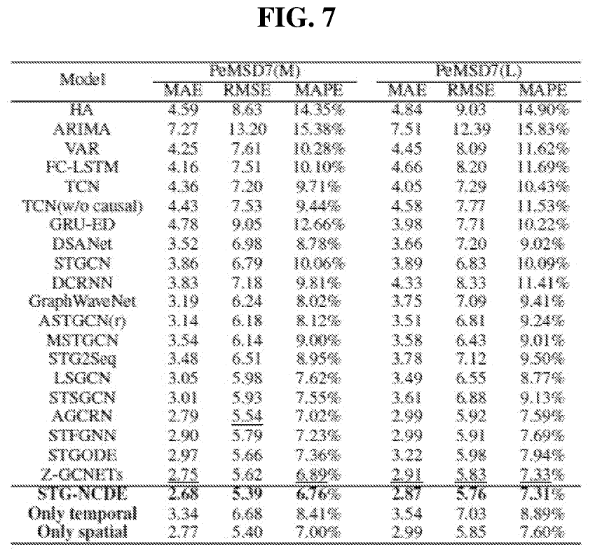

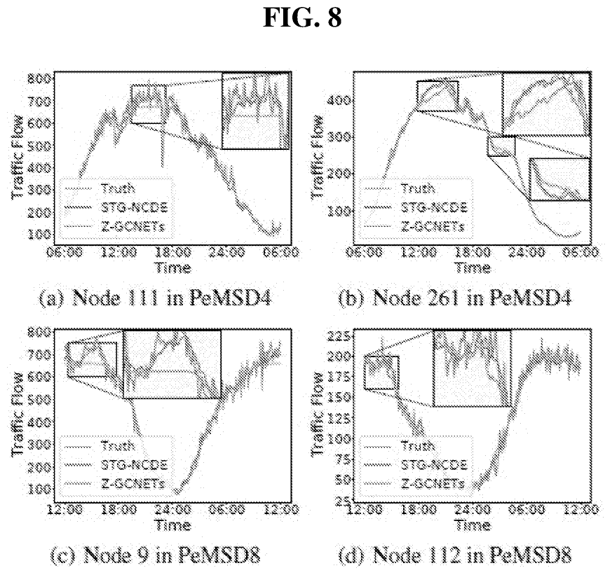

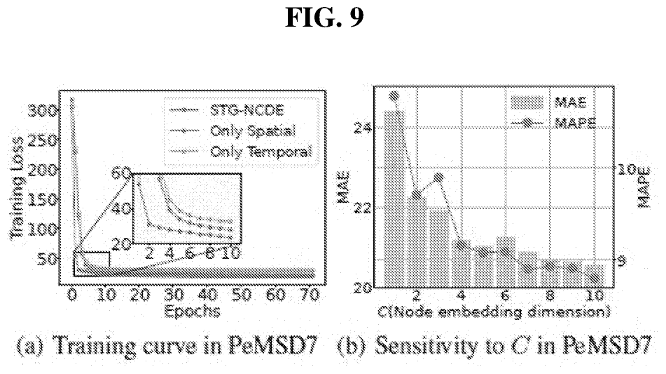

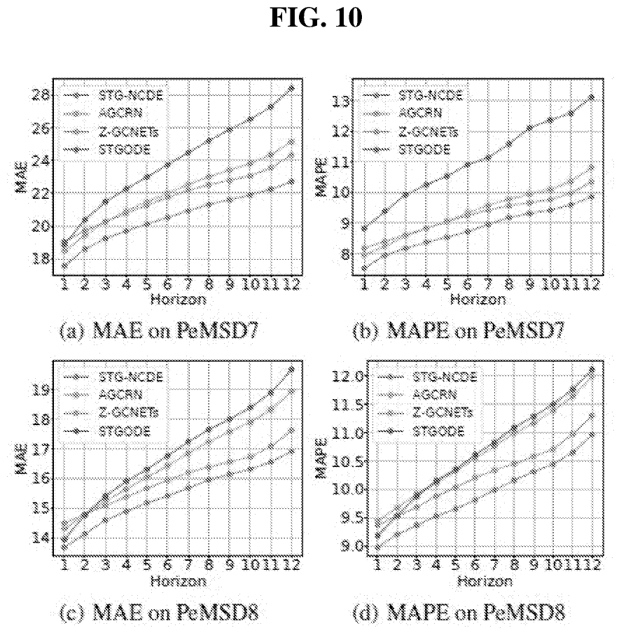

Hereinafter, experimental content regarding the spatiotemporal data processing apparatus and method according to the present disclosure will be described with reference to FIGS. 6 to 10. Specifically, FIG. 6 is a table illustrating forecasting errors of PeMSD3, PeMSD4, PeMSD7, and PeMSD8, and FIG. 7 is a table illustrating forecasting errors of PeMSD7(M) and PeMSD7(L). Further, FIG. 8 illustrates traffic forecasting results, (a) of FIG. 8 illustrates experimental results of node 111 in PeMSD4, (b) illustrates experimental results of node 261 in PeMSD4, (c) illustrates experimental results of node 9 in PeMSD8, and (d) illustrates experiment results of node 112 in PeMSD8. FIG. 9 illustrates training curves and sensitivity analysis results. (a) in FIG. 9 illustrates a training curve in PeMSD7, and (b) illustrates sensitivity results for C in PeMSD7. FIG. 10 illustrates forecasting error results of each horizontal line, (a) in FIG. 10 illustrates MAE results in PeMSD7, (b) illustrates MAE results in PeMSD7, (c) illustrates MAE results in PeMSD8, and (d) illustrates MAPE results in PeMSD8.

First, a time series forecasting experiment is performed here. All experiments can be performed in the following software and hardware environments. That is, Ubuntu 18.04 LTS, Python 3.9.5, Numpy 1.20.3, Scipy 1.7, Matplotlib 3.3.1, torchdiffeq 0.2.2, PyTorch 1.9.0, CUDA 11.4, NVIDIA Driver 470.42, i9 CPU, and NVIDIA RTX A6000. Six datasets and 20 baseline models in one largest experiment in the field of traffic forecasting are used.

### Datasets

In the experiment, six real traffic datasets collected by PeMS: PeMSD7(M), PeMSD7(L), PeMS03, PeMS04, PeMS07 and PeMS08 are used. Details of the datasets used here are shown in Table 1 below.

TABLE 1

| Dataset | [symbol] | Time Steps | Time Range | Type |
|---|---|---|---|---|
| PeMSD3 | 358 | 26,208 | September 2018- | Volume |
| | | | November 2018 | |
| PeMSD4 | 307 | 16,992 | January 2018- | Volume |
| | | | February 2018 | |
| PeMSD7 | 883 | 28,224 | May 2017-August 2017 | Volume |
| PeMSD8 | 170 | 17,856 | July 2016-August 2016 | Volume |
| PeMSD7(M) | 228 | 12,672 | May 2012-June 2012 | Velocity |
| PeMSD7(L) | 1,026 | 12,672 | May 2012-June 2012 | Velocity |

In Table 1 above, various types of values such as i) number of vehicles or ii) speed are included.

### Experimental Settings

The dataset has already been divided into training, verification, and test sets in a 6:2:2 ratio. In this dataset, an interval between two consecutive points in time is five minutes. 12 past graph snapshots are read and then, forecasting settings of S=12 and M=1 are used. A graph snapshot index i starts at 0. Here, 12-sequence-to-12-sequence forecasting that is a standard benchmark set is performed. A mean absolute error (MAE), a mean absolute percentage error (MAPE), and a root mean square error (RMSE) are used to measure the performance of various models.

Baselines: A method (STG-NCDE) according to the present disclosure is compared with a baseline model together with a previous model. 20 baseline models are used.
(1) HA (Hamilton 2020) forecasts a next value using an average value of last 12 time slices.
(2) ARIMA is a statistical model for time series analysis.
(3) VAR (Hamilton 2020) is a time-series model that captures a spatial correlation between all traffic series.
(4) TCN (Bal, Kolter, and Koltun 2018) is configured of a stack of causal convolutional layers with exponentially expanding expansion coefficients.
(5) FC-LSTM (Sutskever, Vinyals, and Le 2014) is an LSTM with fully connected hidden devices.
(6) GRU-ED (Cho et al. 2014) is a GRU-based baseline and utilizes an encoder-decoder framework for multi-stage time series forecasting.
(7) DSANet (Huang et al. 2019) is a correlated time series forecasting model that uses a CNN network and a self-attention mechanism for spatial correlation.

Hyperparameters: The following hyperparameters are tested for the method of the present disclosure. 200 epochs are trained using an Adam optimizer with a batch size of 64 in all datasets. A two-dimension of dim (h^{(ν)}) and dim (z^{(ν)}) is {32, 64, 128, 256}, a node embedding size C is 1 to 10, and the number of K in Equation 8 is {1, 2, 3}. Learning rates of all methods are {1×10⁻², 5×10⁻³, 1×10⁻³, 5×10⁻⁴, 1×10⁻⁴}, and weight decay coefficients are {1×10⁻⁴, 1×10⁻³, 1×10⁻²}. An early stopping strategy with patience of 15 iterations for a verification dataset is used. A best hyperparameter is in (Choi et al. 2021) for reproducibility. In the case of the baseline, when the accuracy for the dataset is unknown, a code is executed through a hyperparameter search process on the basis of a recommended configuration, and when the accuracy for the dataset known, officially reported accuracy is used.

### Experimental Result

FIGS. 6 and 7 show detailed forecasting performance. STG-NCDE, which is the method according to the present disclosure, shows the best average accuracy, as shown in Table 2 below.

TABLE 2

| Model | MAE | RMSE | MAPE |
|---|---|---|---|
| STGCN | 14.88 (117.0%) | 24.22 (113.6%) | 12.30 (121.8%) |
| DCRNN | 14.90 (117.1%) | 24.04 (112.7%) | 12.75 (126.1%) |
| GraphWaveNet | 15.94 (125.39%) | 26.22 (122.9%) | 12.96 (128.2%) |
| ASTGCN(r) | 14.86 (116.9%) | 23.95 (112.3%) | 12.25 (121.3%) |
| STSGCN | 14.45 (113.59%) | 23.58 (110.5%) | 11.42 (113.0%) |
| AGCRN | 13.32 (104.7%) | 22.29 (104.5%) | 10.37 (102.79%) |
| STFGNN | 13.92 (109.5%) | 22.57 (105.8%) | 11.30 (111.9%) |
| STGODE | 13.56 (106.6%) | 22.37 (104.8%) | 10.77 (106.6%) |
| Z-GCNETS | 13.22 (104.0%) | 21.92 (102.7%) | 10.44 (103.4%) |
| STG-NCDE | 12.72 (100.0%) | 21.33 (100.0%) | 10.10 (100.0%) |

Table 2 above lists average MAE, RMSE, and MAPE in the six datasets for each model, and relative accuracy compared to the method (STG-NCDE) of the present disclosure is illustrated in parentheses. For example, STGCN shows a 117.0% worse MAE than the method of the present disclosure. All of existing methods show a worse error in all metrics than the method of the present disclosure.

It is seen from experimental results of the respective datasets, STG-NCDE shows the highest accuracy in all cases, followed by Z-GCNET, AGCRN, and STGODE. There is no existing method that is as stable as STG-NCDE. STGODE shows a very low error in many cases. For example, although in PeMSD3 of STGODE, RMSE of 27.84 is the second best result compared to 27.09 of STG-NCDE, STGODE outperforms AGCRN and Z0GCNET for PeMSD7. Only STG-NCDE, which is the method of the present disclosure, shows reliable forecasting in all the cases.

In FIG. 8, ground-truth and a forecasting curve are visualized by the method of the present disclosure and Z-GCNET. Nodes 111 and 261 visualized in (a) and (b) of FIG. 8 are two places with the highest traffic in PeMSD4, and nodes 9 and 112 visualized in (c) and (d) in FIG. 8 are two places with the highest traffic in PeMSD8. Since Z-GCNET shows reasonable performance, a forecasting curve is similar to the method of the present disclosure at many points in time, but the method of the present disclosure shows much more accurate forecasting for difficult cases, as highlighted by boxes. In particular, the method of the present disclosure greatly outperforms Z-GCNET for the highlighted points in time for the node 111 of PeMSD4 and the node 9 of PeMSD8. Z-GCNET is nonsensical forecasting, that is, the forecasting curve is straight.

### Ablation, Sensitivity, and Additional Studies

Ablation Study: Two models are defined as ablation study models. i) A first ablation model has only a temporal processing part as shown in Equation 4 above, and ii) a second ablation model has only a spatial processing part defined by Equation 12 below.

$$( T ) = Z ( 0 ) + {\int }_{0}^{T} g ( Z ( t ) ; {θ}_{g} ) \frac{dX ( t )}{dt} dt \qquad [ Equation 12 ]$$

Here, the trajectory Z(t) over time is controlled by X(t). Therefore, a model architecture for this ablation study model is changed so that the first model is noted as “Only Temporal” and the second model is noted as “Only Spatial”.

In all cases, the ablation study model having only the spatial processing has much better performance than the ablation study model having only the temporal processing. However, STG-NCDE utilizing both the temporal processing and the spatial processing surpasses this. This shows that both the temporal processing and the spatial processing are necessary to achieve the best model accuracy.

In (a) of FIG.9, a training curve in PeMSD7 is compared. A loss curve of STG-NCDE is stabilized after a second epoch, but two other ablation models require a longer time until the loss curve are stabilized.

Sensitivity to C: (b) of FIG. 9 shows MAE and MAPE with changed the node embedding size C. Both error metrics are stabilized after C=7, and best accuracy can be obtained when C=10.

Error for Each Horizon: Here, S represents a forecasting length, that is, the number of forecasting horizons. A benchmark dataset is set to S=12, and FIG. 10 shows a model error for each forecasting horizon. It is clear that an error level shows a high correlation with S. For all horizons, STG-NCDE shows a smaller error than other baselines.

Irregular Traffic Forecasting: In practice, traffic sensors can be damaged and data cannot be collected for a certain period of time in some areas. To reflect this situation, 10 to 50% of a sensing value for each node are dropped independently and randomly. Because the NCDE can consider irregular time series by design, STG-NCDE can be performed without change in model design, which is one most distinct point from existing baseline. Results thereof are shown in Tables 3 and 4 below.

TABLE 3

| Model | Missing rate | MAE | RMSE | MAPE |
|---|---|---|---|---|
| STG-NCDE | 10% | 19.36 | 31.28 | 12.79% |
| Only Temporal | | 26.26 | 40.89 | 17.66% |
| Only Spatial | | 19.73 | 31.67 | 13.20% |
| STG-NCDE | 30% | 19,40 | 31.30 | 13.04% |
| Only Temporal | | 26.86 | 41.73 | 18.35% |
| Only Spatial | | 19.83 | 31.95 | 13.29% |
| STG-NCDE | 50% | 19.98 | 32.09 | 13.48% |
| Only Temporal | | 28.15 | 43.54 | 19.14% |
| Only Spatial | | 20.14 | 32.30 | 13.30% |

TABLE 4

| Model | Missing rate | MAE | RMSE | MAPE |
|---|---|---|---|---|
| STG-NCDE | 10% | 15.68 | 24.96 | 10.05% |
| Only Temporal | | 21.18 | 33.02 | 13.26% |
| Only Spatial | | 16.85 | 26.63 | 11.12% |
| STG-NCDE | 30% | 16.21 | 25.64 | 10.43% |
| Only Temporal | | 21.46 | 33.37 | 13.57% |
| Only Spatial | | 18.46 | 29.03 | 12.16% |
| STG-NCDE | 50% | 16.68 | 26.17 | 10.67% |
| Only Temporal | | 22.68 | 35.14 | 14.11% |
| Only Spatial | | 17.98 | 28.12 | 11.87% |

The performance of the model of the present disclosure was not greatly degraded as compared to the results of FIG. 6. The other baselines listed in FIG. 6 are unable to perform irregular forecasting, and the STG-NCDE is compared with the ablation models in Tables 3 and 4 above.

An artificial intelligence neural network device based on a co-evolutionary neural ordinary differential equation according to the present disclosure can implement time processing NCDE and spatial processing NCDE models for traffic forecasting. In particular, the NCDE for spatial processing can be regarded as NCED-based analysis of a graph convolutional network. In experiments using six datasets and 20 baselines, the method of the present disclosure clearly shows the best overall accuracy and can perform irregular traffic forecasting in which some input observations may be missing.

Although the above has been described with reference to preferred embodiments of the present disclosure, it will be understood by those skilled in the art that the present disclosure can be variously modified and changed without departing from the spirit and scope of the present disclosure described in the claims below.

[Detailed Description of Main Elements]

100: Spatiotemporal data processing system

| | |
|---|---|
| 110: User terminal | 130: Spatiotemporal data processing |
| | apparatus |

150: Database

| | |
|---|---|
| 210: Processor | 230: Memory |
| 250: User input and output unit | 270: Network input and output unit |
| 310: Main NODE module | 330: Attention NODE module |
| 350: Feature extraction module | 370: Initial attention generation module |
| 390: Classification module | |

What is claimed is:

1. A spatiotemporal data processing apparatus based on a graph neural controlled differential equation comprising:
a preprocessing unit configured to generate a continuous path for each node in time series data; and
a main processing unit configured to combine a graph convolution network (GCN) with a neural controlled differential equation (NCDE) for the generated path to perform integration processing on temporal information and spatial information,
wherein the main processing unit performs temporal processing and spatial processing on each node with two controlled differential equation (CDE) functions to calculate a last hidden vector and forecast an output layer.

2. The spatiotemporal data processing apparatus based on a graph neural controlled differential equation according to claim 1, wherein the preprocessing unit performs an interpolation algorithm on each node to generate the continuous path.

3. The spatiotemporal data processing apparatus based on a graph neural controlled differential equation according to claim 2, wherein the preprocessing unit uses a natural cubic spline as the interpolation algorithm.

4. The spatiotemporal data processing apparatus based on a graph neural controlled differential equation according to claim 1, wherein the main processing unit includes
a first NCDE module configured to perform the temporal processing on the continuous path of each node to generate a hidden trajectory of the temporal information; and
a second NCDE module configured to perform the spatial processing on the continuous path of each node to generate a hidden trajectory of the spatial information.

5. The spatiotemporal data processing apparatus based on a graph neural controlled differential equation according to claim 4, wherein the first NCDE module stakes the hidden trajectories for all the nodes to generate a matrix, and individually processes respective rows of the matrix using a CDE function to convert the matrix into a continuous RNN.

6. The spatiotemporal data processing apparatus based on a graph neural controlled differential equation according to claim 4, wherein the main processing unit further includes an initial value generation module configured to generate initial values of the temporal processing and the spatial processing, and train parameters of an initial value generation layer, a CDE function including a node embedding matrix, and an output layer.

7. A spatiotemporal data processing method based on a graph neural controlled differential equation comprising:
a preprocessing step of generating a continuous path for each node in time series data; and
a main processing step of combining a graph convolution network (GCN) with a neural controlled differential equation (NCDE) for the generated path to perform integration processing on temporal information and spatial information,
wherein the main processing step includes performing temporal processing and spatial processing on each node with two controlled differential equation (CDE) functions to calculate a last hidden vector and forecast an output layer.

8. The spatiotemporal data processing method based on a graph neural controlled differential equation according to claim 7, wherein the preprocessing step includes performing an interpolation algorithm on each node to generate the continuous path.

9. The spatiotemporal data processing method based on a graph neural controlled differential equation according to claim 8, wherein the preprocessing step includes using a natural cubic spline as the interpolation algorithm.

10. The spatiotemporal data processing method based on a graph neural controlled differential equation according to claim 7, wherein the main processing step includes
a temporal processing step of performing the temporal processing on the continuous path of each node through a first NCDE module to generate a hidden trajectory of the temporal information; and
a spatial processing step of performing the spatial processing on the continuous path of each node through a second NCDE module to generate a hidden trajectory of spatial information.

11. The spatiotemporal data processing method based on a graph neural controlled differential equation according to claim 10, wherein the temporal processing step includes staking the hidden trajectories for all the nodes to generate a matrix, and individually processing respective rows of the matrix using a CDE function to convert the matrix into a continuous RNN.

12. The spatiotemporal data processing method based on a graph neural controlled differential equation according to claim 10, wherein the main processing step further includes an initial value generation step of generating initial values of the temporal processing and the spatial processing, and training parameters of an initial value generation layer, a CDE function including a node embedding matrix, and an output layer.
